(19) United States
(12) Patent Application Publication
(10) Pub. No.: US 2009/0174184 A1
(43) Pub. Date: Jul. 9, 2009

(54) WORKING METHOD OF THE EXTERNAL THREADED FRP (FIBERGLASS-REINFORCED PLASTIC) PIPE AND FITTING

(76) Inventor: Bi-Ting LIN, Taipei (TW)

Correspondence Address: Dr. BANGER SHIA, 102 Lindencrest Ct., Sugar Land, TX, 77479-5201, US

(21) Appl. No.: 11/971,774

(22) Filed: Jan. 9, 2008

(51) Int. Cl. F16L 25/04

(52) U.S. Cl. 285/333

(57) ABSTRACT

The invention discloses an external threaded FRP pipe and fitting, in which the outside surface of the FRP pipe and fitting connecting end is added up with a threaded layer, whereof the outside of the threaded layer is molded directly to external thread. The work method of it is that the outside surface of the FRP pipe or fitting connecting end is ground, laminated with resin manually, wound around with glass fiber, and added up with an anti-corrosion layer, whereby it is molded to an external threaded structure through the use of mold. This method has achieved quick connection of the FRP piping system and greatly reduced the operating cost.

### BACKGROUND OF THE INVENTION

(a) Field of the Invention

The invention is related to the technical field of FRP (Fiberglass-Reinforced Plastic) pipes and fittings, especially to the external thread forming structure and its fabrication method for FRP pipes and fittings.

(b) Description of the Prior Art

At present, the FRP connection is usually done by two methods which include flange face connection or socket connections. The flange face connection is that a straight pipe (or fitting) 100 is butt connected with flange 110 first as shown in FIGS. 1 & 2, whereof the joint 120 is coated with resin and glass fiber to fix the straight pipe (or fitting) 100 and flange 110 together, and further through face connection with flange 110 to achieve pipe connection. The socket connection is as shown in FIGS. 3 & 4 that a straight pipe (or fitting) 200 is inserted into the slip ring 230 of the sleeve pipe 210, whereof the socket joint 220 is coated with resin and glass fiber to fix the straight pipe (or fitting) 200 and sleeve pipe 210 together to achieve pipe connection. However, as the two methods demand higher skills of workers, in developed countries such as USA, workers are required to attain corresponding qualifications. Since if human errors occur during the connection process, not only that the required anti-corrosion or anti-pressure level may be failed to achieve, but leaking incidents may also happen. In addition, the two connection methods are in slow process, it takes 4 hours after connection to be dried and ready for use, consequently the work intermissions and waiting caused by the installation will result in some losses that then make the cost relatively higher. Hence, the two methods definitely need to be improved.

Another less used connection method is to machine thread 310 on the outside surface of FRP pipe 300 as shown in FIGS. 5 & 6, whereby it is connected with the female connector 320 to achieve pipe connection. However, the machined thread 310 seriously harms the product structure of pipe 300 that makes the wall of pipe 300 thinner and weaker in strength, so does the anti-pressure and anti-corrosion performance of the product decrease significantly. Therefore, this type of connection is usually not adopted in the industry.

In view of this, the inventor has researched hard on the FRP pipe connection technology and finally developed the fast-connectable, low cost and low worker's skill demanding external threaded FRP pipe and fitting that can resolve the present headache of FRP pipe connection brought to the industry and further to result in this application.

### SUMMARY OF THE INVENTION

The purpose of the invention is to provide a kind of external threaded FRP pipe and fitting and the machining method for the said external threaded FRP pipe and fitting in order to achieve quick connection for FPR Piping system and save the operating cost.

To achieve the said purpose, the resolution of the invention is the following:

The external threaded FRP pipe and fitting, whereof the outside surface of the FRP pipe or fitting connecting end is added with a threaded layer while the external surface of the said threaded layer is directly molded to external thread.

The said threaded layer is composed of resin and glass fiber which is laminated on top of outside surface of FRP pipe or fitting connecting end. This glass fiber impregnated with resin is wound around the outside surface of FRP pipe or fitting connecting end repeatedly until desire thickness is achieved. An anti-corrosion material than will be laid-up on top of built glass fiber layers. While the built up glass fiber lamination is still wet, a set of steel match molds is deployed and clipped on glass fiber lamination to form the threads.

By adopting the above method in the invention, as the outside surface of the FRP pipe or fitting connecting end is additionally added up a threaded layer, whereof the said threaded layer is integrated with the outside surface of the FRP pipe or fitting connecting end, the connecting end wall thickness of the FRP pipe and fitting is greatly thickened, whereof the outside surface of the threaded layer is molded to external tread which is not obtained by machining, as such the external tread formation of the invention ensures the product structure of pipe and fitting free of damage and its strength, anti-pressure and anti-corrosion performances. In piping connection, by using the formed external thread on the connecting end of the FRP pipe of the invention to fit with the internal thread of the female connector, the quick pipe connection can be achieved, while the drying and fixation only takes half hour before the pipe can be used. It has overcome the disadvantages of current piping connection methods such as high skilled worker requirement, time and manpower consuming in field installation etc and has avoided the losses caused by work intermissions or waiting due to long installation time, greatly decreased the field installation cost as well as promoted the feasibility of connecting the FRP pipe and fitting by external thread, thereby it can be extended for wider applications with significant economic effectiveness.

### BRIEF DESCRIPTION OF THE DRAWINGS

FIG. 1 is a 3D outlook drawing of FRP pipe in flange face connection;

FIG. 2 is a plane view of a FRP pipe in flange face connection;

FIG. 3 is a 3D outlook drawing of a FRP pipe in socket connection;

FIG. 4 is a plane view of a FRP pipe in socket connection;

FIG. 5 is a 3D explosion view of a FRP pipe in external thread connection by the existing art;

FIG. 6 is a structure schematic drawing of an external threaded pipe of the existing art;

FIG. 7 is a structure schematic drawing of the invention;

FIG. 8 is a partial enlarge view of the invention;

FIG. 9 is the outlook schematic drawing of the invention;

FIG. 10 is a structure schematic drawing of the invention showing the connection with a female connector;

FIG. 11 is a work method flow chart of the invention.

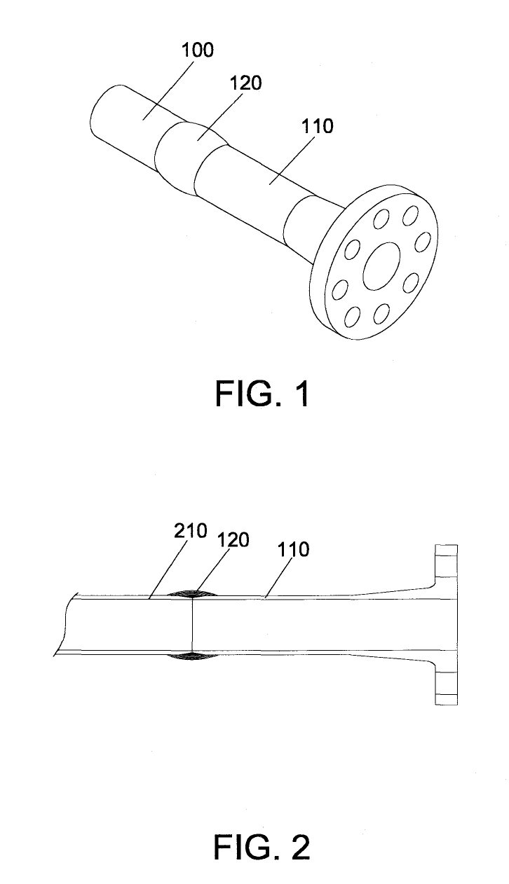

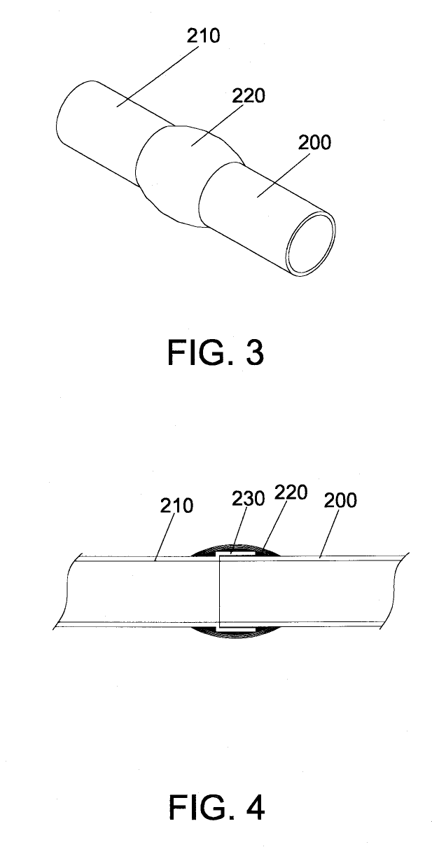

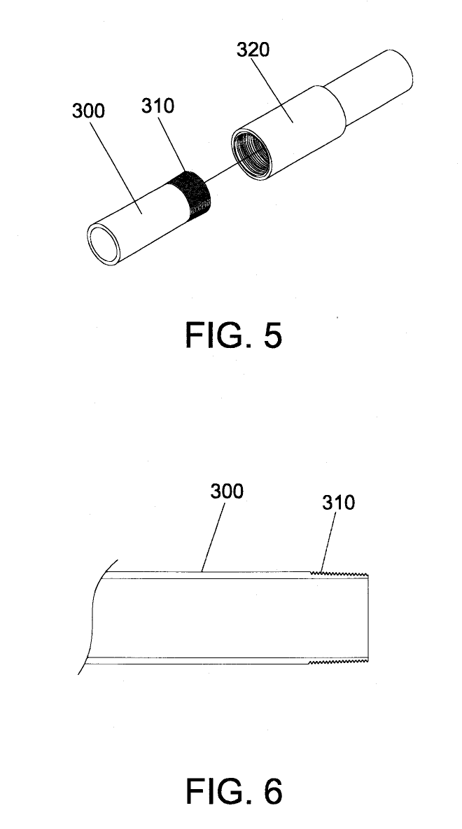

### DETAILED DESCRIPTION OF THE PREFERRED EMBODIMENTS

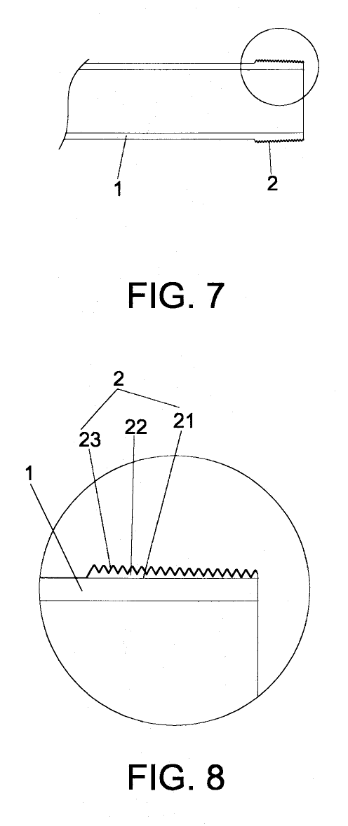

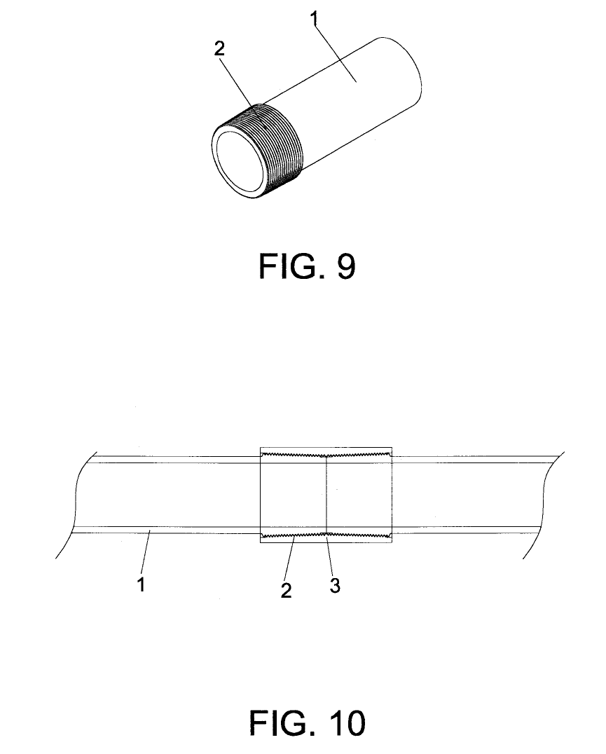

The preferred embodiment of the invention is shown in FIGS. 7 & 9, wherein the FPR pipe of external thread is used as the example for describing the invention while the FRP piping of external thread is similar to this case, please also refer to the preferred embodiment. The improvement of the invention is the following:

The connecting end of FRP pipe 1 is added another threaded layer 2, whereof the said threaded layer 2 is shown in FIG. 8, it is composed of the resin 21 which is pasted on the outside surface of connecting end of the FRP pipe 1 and the glass fiber 22 which is wound around the outside surface of connecting end of the FRP pipe 1, whereof an anti-corrosion layer 23 is on top of the surface of threaded layer 2, thereby the said threaded layer 2 is integrated with the outside surface of the FRP pipe 1 or fitting connecting end, and the outside surface of threaded layer 2 is directly molded to external thread.

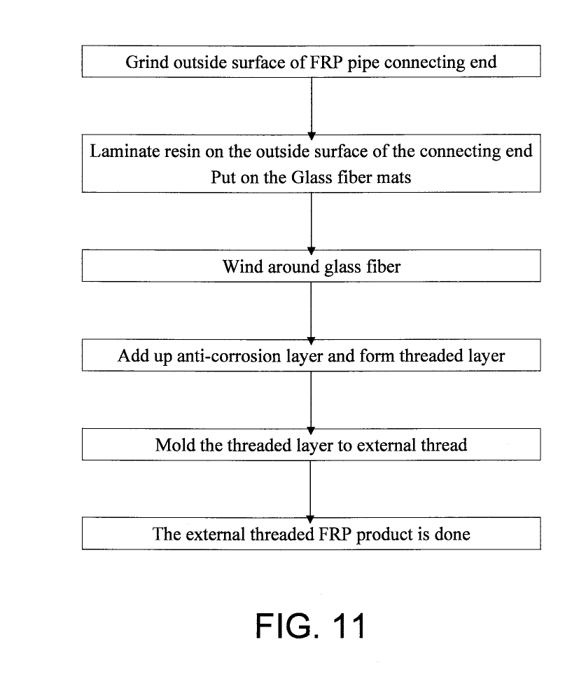

The detail procedures are shown in FIG. 11: Grind the outside surface of the connecting end of the FRP pipe 1, manually paste the outside surface of the connecting end with resin 21, and put on glass fiber mats, further wind around glass fiber 22 and add up the anti-corrosion layer 23 which is then molded to an external thread structure through the use of a special mold, whereby to combine the FRP pipe 1 and threaded layer 2 into an integrated structure which not only ensures the product structure of pipe and fitting free of damage, but also its strength, anti-pressure and anti-corrosion performances.

The pipe connection of the invention as shown in FIG. 10, by using the threaded layer 2 and the external thread of the FRP pipe 1 to fit with the internal thread of the female connector 3, the quick pipe connection can be achieved while the drying and fixation only takes half hour before the pipe can be used. It has overcome the disadvantages of current piping connection methods such as high skilled worker requirement, time and manpower consuming in field installation etc and has avoided the losses caused by work intermissions or waiting due to long installation time, greatly decreased the field installation cost as well as promoted the feasibility of connecting the FRP pipe and fitting by external thread, thereby it can be extended for wider applications with significant economic effectiveness.

The aforesaid embodying examples only describe the technical thoughts and characteristics of the invention, its purpose is to let technical personnel understand the content of the invention and carry out accordingly. However, all variations or modifications, not limited to the claimed scope of the invention if based on spirit of the invention shall still be covered in the claimed scope of the invention.

1. The external threaded FRP pipe and fitting which is characterized in that a threaded layer is added to the outside of the FRP pipe or fitting connecting end, whereof the outside surface of the threaded layer is molded to external thread.

2. The external threaded FRP pipe and fitting as in claim 1 which is characterized in that the threaded layer is composed of the resin which is laminated on the outside surface of connecting end of the FRP pipe or fitting and the glass fiber which is wound around the outside surface of connecting end of the FRP pipe and fitting.

3. The external threaded FRP pipe and fitting as in claim 1 which is characterized in that an anti-corrosion layer is on top of the threaded layer.

4. The work method on the external threaded FRP pipe and fitting, whereof it is characterized in that the outside surface of the FRP pipe or fitting connecting end is ground, the outside surface of the connecting end is laminated with resin manually, wound around with glass fiber, and added up an anti-corrosion layer, whereby it is molded to external thread through the use of mold.
